(19) United States
(12) Patent Application Publication
(10) Pub. No.: US 2016/0270624 A1
(43) Pub. Date: Sep. 22, 2016

(54) RECYCLABLE CLEANING ARTICLE

(71) Applicant: Veronique CLOUTIER, Beloeil (CA)

(72) Inventor: Veronique CLOUTIER, Beloeil (CA)

(21) Appl. No.: 15/031,306

(22) PCT Filed: Oct. 23, 2014
(86) PCT No.: PCT/CA2014/000770

§ 371 Date: Apr. 22, 2016

(30) Foreign Application Priority Data
Oct. 23, 2013 (CA) 2831200

(51) Int. Cl. A47L 13/24; A47L 17/00; B25G 1/10; A47L 13/42

(52) U.S. Cl. CPC A47L 13/24; A47L 13/42; A47L 17/00; B25G 1/102

(57) ABSTRACT

A recyclable cleaning article. The cleaning article includes a recyclable polymer handle to be manipulated by a user. The cleaning article also includes a cleaning head attached to the handle. The cleaning head has a plurality of flaccid cleaning elements. Each cleaning element includes a plurality of cords, and each cord is formed of recyclable polymer filaments. The cords of each cleaning element are interlaced together.

### TECHNICAL FIELD

The application relates generally to devices used for cleaning and, more particularly, to a recyclable cleaning article.

### BACKGROUND OF THE ART

A conventional cleaning device is often made from a variety of different materials (e.g. wood, metal, cotton, plastics, etc.). Such cleaning devices are difficult, if not impossible, to dispose of sustainably either by recycling them, or by allowing them to organically decompose. Indeed, most of these cleaning devices are designed so that they can be disposed of at the end of their useful lives as non-recyclable garbage. They then typically sit in landfills, breaking down into their constituent parts over decades or centuries.

Even where such cleaning devices have a recyclable component, the component cannot be removed easily from the cleaning device in order to be recycled. Furthermore, it is not always evident to a user that the component is recyclable. The result is that most users of such a cleaning devices will not trouble themselves to separate the components, and will simply throw the entire cleaning device out with the non-recyclable garbage.

### SUMMARY

In one aspect, there is provided a recyclable cleaning article, comprising: a recyclable polymer handle to be manipulated by a user; and a cleaning head attached to the handle and comprising a plurality of flaccid cleaning elements, each cleaning element comprising a plurality of cords, each cord formed of recyclable polymer filaments, the cords of each cleaning element being interlaced together; each of the recyclable polymer filaments and the recyclable polymer handle being made of a same recyclable polymer material.

In another aspect, there is provided a recyclable cleaning article, comprising: a recyclable polymer handle to be manipulated by a user; and a plurality of recyclable polymer flaccid cleaning elements attached to the recyclable polymer handle; each of the recyclable polymer handle and cleaning elements being made of a same recyclable polymer material.

### DESCRIPTION OF THE DRAWINGS

Reference is now made to the accompanying figures in which:

FIG. 1A is a perspective view of a recyclable cleaning article, according to an embodiment of the present disclosure;

FIG. 1B is an exploded view of the cleaning article of FIG. 1A;

FIG. 1C is an enlarged view of one of the cleaning elements of the cleaning article of FIG. 1A;

FIG. 2A is an enlarged view of a cleaning element, according to another embodiment of the present disclosure;

FIG. 2B is an enlarged view of another cleaning element, according to yet another embodiment of the present disclosure; and

FIG. 2C is an enlarged view of yet another cleaning element, according to yet another embodiment of the present disclosure.

### DETAILED DESCRIPTION

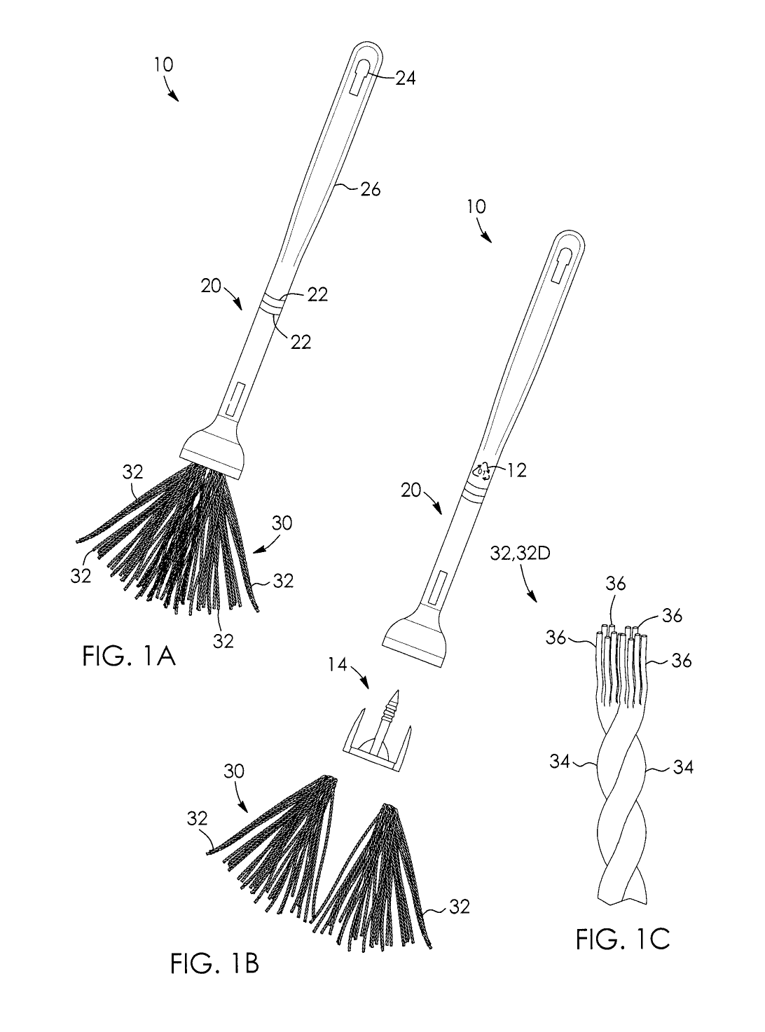

FIG. 1A illustrates a recyclable cleaning article 10. The recyclable cleaning article 10 (or simply “cleaning article 10”) can be any tool which can be used to engage or abrade a surface in order to clean the surface. As such, the cleaning article 10 can take any configuration or shape, and is not limited to the floor mop/dishwashing mop shown in FIG. 1A. The term “recyclable” refers to the ability of a user to discard the cleaning article 10 at the end of its useful life by disposing of it in any municipal, state, national, or private recycling facility so that the components and/or materials making up the cleaning article 10 can be recuperated. The term “recyclable” does not imply that the cleaning article 10 must be used only once. Indeed, and as will be discussed in greater detail below, the cleaning article 10 is durable and can be used repeatedly. The cleaning article 10 has a recyclable polymer handle 20 and a cleaning head 30, both of which are now discussed.

The recyclable polymer handle 20 (or simply “handle 20”) allows a user to grip the cleaning article 10 in order to apply it against a surface to be cleaned. As such, the handle 20 can take any suitable shape or configuration. In FIG. 1A, the handle 20 is an elongated device which allows the user to apply the cleaning article 10 against surfaces located a distance away from the user. The length of the handle 20 can vary depending on the intended application of the cleaning article 10. For example, the length of the handle 20 of a floor cleaning article 10 will be greater than the length of the handle 20 of a dishwashing cleaning article 10. Similarly, where the cleaning article 10 is a scrubbing brush, the handle 20 can be short and hemispherical because the user must be close to the surface being cleaned.

The handle 20 can include many different features that improve its utility and ergonomic functionality. For example, the handle 20 can have one or more ribs 22 or protrusions from its surface, which allow the handle 20 to be better gripped by the user. The handle 20 may also have a hole 24 which allows the cleaning article 10 to be hung while being stored. The handle 20 can also have an ergonomic body 26 which provides a more comfortable grip for the user. The handle 20 can also have a hollow interior, which helps to reduce the material costs of the cleaning article 10. The handle 20 is made of a recyclable polymer. As explained above with respect to the cleaning article 10, this allows the handle 20 to be disposed of in any suitable municipal, state, national, or private recycling facility so that the components and/or materials making up the handle 20 can be recuperated.

The cleaning article 10 also includes a cleaning head 30. The cleaning head 30 is the portion of the cleaning article 10 which engages the surface to be cleaned, and which is abraded thereagainst. The cleaning head 30 can therefore be any mop head, brush head, or other similar cleaning extremity. The cleaning head 30 is attached to the handle 20, and in some configurations, can be integral with the handle 20. Such integrality may facilitate the manufacturing of the cleaning article 10 because it eliminates the need to attach a separate cleaning head 30. The cleaning head 30 includes multiple cleaning elements 32, which are now discussed.

Referring to FIGS. 1B and 1C, the cleaning elements 32 are engaged with the surface to be cleaned through the user's manipulation of the cleaning article 10. The cleaning elements 32 are limp or flaccid, which allows them to easily engage the surface to be cleaned, and to fit into its crevices and crannies. For example, the flaccidity of the cleaning elements 32 allows them to clean each of the surface of a dining plate, the interior of a mug, and between the tines of a fork with the same ease. Each cleaning element 32 can therefore be a plait, weave, braid, or other similar flaccid object.

Each cleaning element 32 is composed of multiple cords 34, each of which is itself composed of multiple recyclable polymer filaments 36 (or simply “filaments 36”). Each cord 34 is therefore a string or yarn made of multiple filaments 36 which are braided, twisted, plaited, woven, or otherwise brought together. The cords 34 can vary in thickness and length. Some examples include a thickness between about 1 mm and about 10 mm, and a length between about 25 mm and about 125 mm. The filaments 36 are relatively fine threads or fibers which are made from a recyclable polymer, as discussed below. Since each cleaning element 32 is an agglomeration of cords 34, and each cord 34 is itself an agglomeration of recyclable polymer filaments 36, it follows that each cleaning element 32 is also made from a recyclable polymer.

Each cleaning element 32 is formed by interlacing together its cords 34. The term “interlace” and its derivatives refer to the crossing, weaving, braiding, intertwining, etc. together of the cords 34 into any given pattern in order to form each cleaning element 32. The interlacing of the cords 34 provides durability, structure, and abrasive ability to each cleaning element 32. It has been observed that employing cleaning elements 32 composed of cords 34 which are not interlaced, even when made of a recyclable polymer, may lead to a relatively rapid unravelling of the filaments 36 making up the cords 34, and thus to an unravelling of the cleaning elements 32. It has also been observed that cords 34 which are not interlaced may lead the cleaning elements 32 to form knots or balls, thereby reducing their effectiveness in cleaning a surface. It has also been observed that cords 34 which are not interlaced tend to frizz relatively quickly, or do not dry as quickly as desired. When they are interlaced together, the cords 34 form a pattern or texture for their corresponding cleaning element 32, and allow the cleaning elements 32 to be abraded against a surface to clean said surface.

Each of the recyclable polymer filaments 36 (i.e. the cleaning elements 32) and the recyclable polymer handle 20 are made of the same recyclable polymer material. It therefore follows that the cleaning article 10 itself is made of one recyclable polymer material. This improves the sustainability of the cleaning article 10 because a user is not required to disassemble the cleaning article 10 into its constituent filaments 36 and handle 20, and can simply recycle the entire cleaning article 10. The use of the same recyclable polymer material may also facilitate the manufacturing of the cleaning article 10.

The expression “recyclable polymer material” refers to any polymer which is habitually accepted in a recycling facility. These polymers include polymers having additives which allow them to be manipulated, such as by extrusion, injection moulding, or other suitable techniques. These additives include, but are not limited to, antacids, antioxidants, and clarifying agents. These additives also include, but are not limited to, the following compositions: calcium stearate, calcium pelargonate, zinc oxide, calcium carbonate, and sterically hindered phenol groups.

The recyclable polymer material may be polypropylene (PP). PP is generally hydrophobic such that it does not absorb water, and is thus quick to dry. PP also has inherently desirable anti-bacterial properties which helps to minimise or eliminate odours. Furthermore, PP does not react with common household bleach. It is therefore possible to clean or disinfect cleaning elements 32 made from PP by using bleach, without degrading the cleaning elements 32. PP can also be relatively easily molded above a certain temperature, which allows the PP filaments 36 and/or cords 34 to be thermo-molded together at their ends, which can improve their durability.

The recyclable polymer material can also be polyethylene (PE), of all grades (e.g. high-density polyethylene or HDPE, low-density polyethylene or LDPE, etc.). PE is also hydrophobic, has desirable anti-bacterial properties, and does not react with common household bleach. Other possible recyclable polymer materials include, but are not limited to: polyethylene terephthalate (PET), polyester, polyvinyl chloride (PVC), and polystyrene (PS). These recyclable polymer materials do not absorb water, are relatively easy to keep clean, and resist and/or eliminate the proliferation of bacteria and other microorganisms. The recyclable polymer material can also be selected from the group of recyclable bio-polymers or bio-plastics, such as certain recyclable grades of polylactic acid (PLA) and/or polyhydroxyalkanoates (PHAs). The recyclable polymer material can also be nylon. The recyclable polymer material can be derived from original sources of polymers, or from polymers recovered through recycling.

The properties of the recyclable polymer filaments 36, and thus of the cords 34 formed therewith, can vary. The cords 34 can be measured with the unit denier (D), which is a unit of measure for the linear mass density of the cord 34. The D value is expressed as mass in grams per 9,000 meters. Therefore, a value of 800 D, for example, indicates that the cord 34 has a linear mass density of 800 g per 9,000 meters. In order to determine the linear mass density per filament, or denier per filament (DPF), the D value must be divided by the number of filaments 36 in the cord 34. Therefore, a cord 34 having a value of 800 D and composed of 140 recyclable polymer filaments 36 will have a DPF value of 800/140, or 5.71. Some possible D and DPF values for the recyclable polymer cords 34 disclosed herein are now given. A cord 34 with a linear mass density of about 800 D and having about 140 recyclable polymer filaments 36 will have a DPF value of 5.71. A cord 34 with a linear mass density of about 400 D and having about 70 recyclable polymer filaments 36 will have a DPF value of 5.71. A cord 34 with a linear mass density of about 200 D and having about 36 recyclable polymer filaments 36 will have a DPF value of 5.56. A cord 34 with a linear mass density of about 150 D and having about 36 recyclable polymer filaments 36 will have a DPF value of 4.17. One or more of the cords 34 can have linear mass density values of about 25 D. Other D values are also within the scope of the present disclosure.

Although often inherently antibacterial and antifungal by way of their material properties, the recyclable polymer filaments 36 can be provided with an antifungal and/or antibacterial agent to further help reduce or prevent the growth of undesirable microorganisms on the surface of the cleaning elements 32. These agents can be added when the recyclable polymer is being prepared. These agents include, but are not limited to salts of silver, derived compositions of zinc, solutions of antifungal or microbial organic compounds. These solutions include a dispersion of N-butyl-1,2-benzisothiazolin-3-one and/or 2-pyridine-thiol-1-oxyde of zinc in diisononylphthalate. The antibacterial agents can include : Polybatch® ABACT, Polybatch® AMIC, Zinc Omadine®, Romcolor 2000® et Safetouch® antimicrobial.

Some or all of the recyclable polymer filaments 36 of a given cord 34 can also include an anti-stain agent or a colorant, which can also be added during preparation of the recyclable polymer material. The anti-stain agent helps to prevent the penetration of substances (e.g. sauces) which may stain or colour the cleaning elements 32. These agents include, but are not limited to, the following compounds: amides (monoamides, diamides, substituted oxamides), silicones (with or without fluoride groupings), polyuerthanes (with or without fluoride groupings), alkyl fluorides, surfactant agents (principally non-ionic surfactants and/or cationic surfactants), cyclic acid anhydrides, hexahydrotriazines, esters of isocyanurate, and disubstituted ureas. Some of these agents can serve other functions as well, such as acting as antistatic agents or as lubricants.

The type of recyclable polymer material can be displayed on the handle 20 with a recycling code 12. The recycling code 12 identifies the type of material, and more specifically, the type of recyclable polymer material of which the handle 20 and the filaments 36 are composed. For example, the recycling code 12 with the number 1 indicates that the cleaning article 10 is made of polyethylene terephthalate (PET). Similarly, the recycling code 12 with the number 2 indicates the cleaning article 10 is made of high-density polyethylene (HDPE). The following recycling codes 12 designate the following recyclable polymer materials: code 3 indicates polyvinyl chloride (PVC), code 4 indicates low-density polyethylene (LDPE), code 5 indicates polypropylene (PP), code 6 designates polystyrene (PS), and code 7 indicates other plastics, such as bio-plastics. The recycling code 12 therefore indicates to the consumer or user of the cleaning article 10 whether it can be recycled in their governmental or private recycling facility, and thereby allows them to feel comfortable in disposing of the cleaning article for recycling. The recycling code 12 also indicates to the employee of the recycling facility that the cleaning article 10, in its entirety, can be recycled in their facility.

In some embodiments, the cleaning article 10 can include an attachment mechanism 14. The attachment mechanism 14 is mounted to, and can be removed from, the end of the handle 20 which is opposite to its free end. The cleaning head 30 and the cleaning elements 32 are attached to the attachment mechanism 14. The attachment mechanism 14 therefore serves as an intermediary between the handle 20 and the cleaning head 30. The attachment mechanism 14 therefore allows the user to replace the handle 20, cleaning elements 32, and/or cleaning head 30 as desired. In order to improve the recyclability of the entire cleaning article 10, the attachment mechanism 14 can be made of the same recyclable polymer material as the handle 20 and the filaments 36.

As previously discussed, the cords 34 can be interlaced together to form cleaning elements 32 having different patterns or textures, some of which are now described.

Referring to FIG. 1C, the cords 34 of each cleaning element 32 can be braided together to form a braided or chainette cleaning element 32D. Such a braided cleaning element 32D can be formed by intertwining two or more cords 34, such as by braiding them together using a knitting process, so that they overlap in a zigzagging pattern. At the end of the braid, the cords 34 can be fused together if so desired. Such a braided cleaning element 32D has better durability when compared to cords 34 which are not interlaced, in that it can better resist the repeated loads acting against the braided cleaning element 32D when used to repeatedly clean a surface. The overlapping segments of the cords 34 also provide abrasive portions to the braided cleaning element 32D, which helps the cleaning element 32 to frictionally engage the surface to be cleaned.

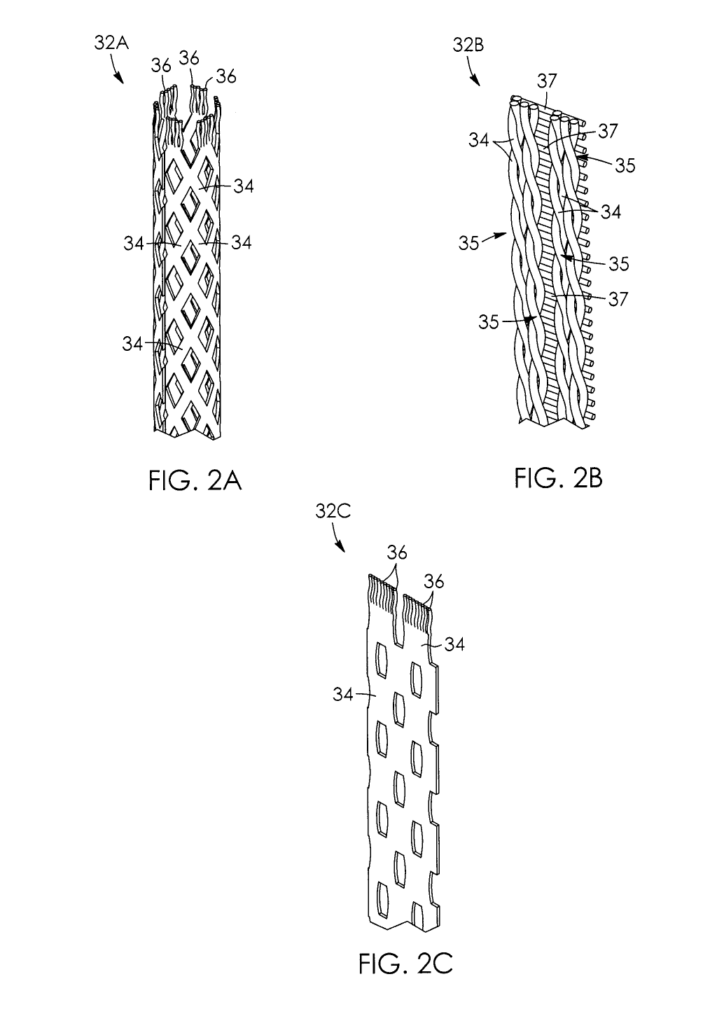

Referring to FIG. 2A, the cords 34 of each cleaning element 32A can be interwoven together to form a woven cleaning element 32A. Such a woven cleaning element 32A can be formed by interweaving two cords 34 at an angle to one another (generally perpendicularly) to form a pattern. At the end of the weave, the cords 34 can be fused together if so desired. Such a woven cleaning element 32A has better durability when compared to cords 34 which are not woven together, in that it can better resist the repeated loads acting against the woven cleaning element 32A when used to repeatedly clean a surface.

FIG. 2B shows another pattern for the cleaning element 32B. The cleaning element 32B is made up of two or more cord pairings 35, where each cord pairing includes two elongated cords 34. Each of the cords 34 in each of the cord pairings 35 extend in parallel to one another, and in parallel to an adjacent cord pairing 35. The cord pairings 35 are attached together with multiple recyclable polymer filament ties 37, which are spaced apart along the length of the cord pairings 35. Each filament tie 37 typically includes more than one filament 36. In most instances, each of the filament ties 37 are oriented in a direction which is transverse to the length of the cords 34 and the cord pairings 35. Such a cleaning element 32B has relatively good durability, and the intersections of the cords 34 with the filament ties 37 provide abrasive portions which help to frictionally engage the surface to be cleaned.

FIG. 2C shows another pattern for the cleaning element 32C. The cords 34 of cleaning element 32C are interlaced together to form a chain-knit, or warp knitting, pattern. Such a warp knitting pattern may be suitable where it is desired that the cleaning element 32C be less abrasive, or where it is desired that the cleaning element 32C dry quicker. The warp knitting pattern may also help the cleaning element 32C to better generate a lather when soap is being used.

Such a warp-knit cleaning element 32C can be made from a warp-knitted fabric which is precision cut into strips, forming individual cleaning elements 32C of warp-knitted mesh fabric. The warp-knitted fabric can be heat shrunk prior to being cut into strips. Such a chain-knit cleaning element 32 may have improved durability.

It will thus be appreciated that the cleaning elements 32 can have different textures and patterns, only some of which have been discussed above. The selection of which pattern and/or texture to use for a cleaning element 32 can depend on multiple factors, such as the intended use of the cleaning article 10, the amount of abrasion needed for cleaning the surface, the manufacturing complexity and cost, and the amount of maintenance provided by the user of the cleaning article 10, to name but a few factors.

In accordance with another embodiment, there is provided a kit for the cleaning article 10. The kit can include one or all of the cleaning head 20, multiple cleaning elements 32, the attachment mechanism 14, and the handle 20. The kit can be used to replace one or all of these components if they become damaged or worn. For example, the kit may include the cleaning head 20 and the attachment mechanism 14, and can be interchanged with the existing cleaning head 20 and attachment mechanism 14, which have been worn out from use.

In light of the above, it can be appreciated that the recyclable cleaning article 10 disclosed herein provides cleaning elements 32 which are typically more durable than cotton or natural fiber equivalents. In further contrast with cotton and other similar materials which absorb moisture, the recyclable polymer cleaning elements 32 repel water and thus do not provide a medium for the growth of odour-producing organisms. Indeed, the soaking of cotton and other similar materials is necessary because the material frictionally engages the surface to be cleaned better when it is wet. This is in contrast to the disclosed cleaning elements 32, which do not require moisture to frictionally engage the surface to be cleaned.

The recyclable polymer material used for the cleaning article 10 also has properties which are inherently antibacterial and/or antifungal, thereby reducing or eliminating the need to treat a natural fiber thread with chemicals. Furthermore, and in contrast to known stiff polymer fibers which are not interlaced together, the flaccid and interlaced cleaning elements 32 are more pliable and thus better suited than the stiff polymer fibers for cleaning surfaces.

Furthermore, the recyclable polymer material which makes up the cleaning article 10 allows the user to recycle the cleaning article 10 at the end of its useful life with a minimal amount, or no, disassembly prior to doing so. The cleaning article 10 disclosed herein is therefore recyclable in its entirety, durable, resistant to stains and bacteria (i.e. odours), and easily maintained.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A recyclable cleaning article, comprising:
a recyclable polymer handle to be manipulated by a user; and
a cleaning head attached to the handle and comprising a plurality of flaccid cleaning elements, each cleaning element comprising a plurality of cords, each cord formed of recyclable polymer filaments, the cords of each cleaning element being interlaced together;
each of the recyclable polymer filaments and the recyclable polymer handle being made of a same recyclable polymer material.

2. The cleaning article of claim 1, wherein the cords of each cleaning element are interwoven together and form woven cleaning elements.

3. The cleaning article of claim 1, wherein the cords of each cleaning element are braided together and form braided cleaning elements.

4. The cleaning article of claim 1, wherein the cords of each cleaning element are interlaced together and form a warp-knit pattern.

5. The cleaning article of claim 1, wherein each cleaning element comprises at least two cord pairings, each cord pairing comprising two elongated cords extending in parallel to one another and to an adjacent cord pairing, each cord pairing linked to an adjacent cord pairing via a plurality of recyclable polymer filament ties.

6. The cleaning article of claim 5, wherein each of the recyclable polymer filament ties extend transverse to the cord pairings linked thereby.

7. The cleaning article of claim 1, wherein the handle includes a recycling code displayed thereon, the recycling code selected from the group of recycling codes consisting of 1, 2, 3, 4, 5, 6, and 7.

8. The cleaning article of claim 1, further comprising an attachment mechanism removably mountable to the handle, the cleaning head attached to the attachment mechanism.

9. The cleaning article of claim 8, wherein the attachment mechanism is made of the same recyclable polymer material as the handle and the recyclable polymer filaments.

10. The cleaning article of claim 1, wherein the recyclable polymer material is polypropylene.

11. The cleaning article of claim 1, wherein the recyclable polymer material is polyethylene or nylon.

12. The cleaning article of claim 1, wherein each of the cords has a linear mass density of about 800 D and about 140 recyclable polymer filaments.

13. The cleaning article of claim 1, wherein each of the cords has a linear mass density of about 400 D and about 70 recyclable polymer filaments.

14. The cleaning article of claim 1, wherein each of the cords has a linear mass density of about 200 D and about 36 recyclable polymer filaments.

15. The cleaning article of claim 1, wherein each of the cords has a linear mass density of about 150 D and about 36 recyclable polymer filaments.

16. The cleaning article of claims 1, wherein each of the cords has a linear mass density of about 25 D.

17. The cleaning article of claim 1, wherein each of the recyclable polymer filaments comprise an antifungal agent or an antibacterial agent.

18. The cleaning article of claim 1, wherein each of the recyclable polymer filament ties comprises an anti-stain agent.

19. The cleaning article of claim 1, wherein the cleaning elements of the cleaning head are integral with the handle.

20. A recyclable cleaning article, comprising:
a recyclable polymer handle to be manipulated by a user; and
a plurality of recyclable polymer flaccid cleaning elements attached to the recyclable polymer handle;
each of the recyclable polymer handle and cleaning elements being made of a same recyclable polymer material.
